(19) United States
(12) Patent Application Publication
(10) Pub. No.: US 2010/0055339 A1
(43) Pub. Date: Mar. 4, 2010

(54) METHOD OF FORMING MOLYBDENUM BASED WEAR RESISTANT COATING ON A WORKPIECE

(76) Inventors: Sachin R. Shinde, Oviedo, FL (US); Anand A. Kulkarni, Oviedo, FL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/198,478

(22) Filed: Aug. 26, 2008

(51) Int. Cl. B05D 1/10; B05D 7/24

(52) U.S. Cl. 427/451; 427/455; 427/450; 427/452; 427/456

(57) ABSTRACT

A method is for forming a wear resistant coating on a workpiece. The method includes atomizing a metallic liquid including molybdenum in an atmosphere to form a crystalline metallic powder including molybdenum. The crystalline metallic powder is milled to form a nanocrystalline metallic powder including molybdenum. Moreover, the method includes thermal spraying the nanocrystalline metallic powder including molybdenum onto the workpiece.

### FIELD OF THE INVENTION

The present invention relates to the field of wear resistant coatings, and, more particularly, to nanocrystalline wear resistant coatings and associated methods.

### BACKGROUND OF THE INVENTION

A combustion turbine typically includes, in a serial flow relationship, a compressor section to compress the entering airflow, a combustion section in which a mixture of fuel and the compressed air is burned to generate a propulsive gas flow, and a turbine section that is rotated by the propulsive gas flow.

The compressor section typically includes a rotor assembly rotatably positioned in a casing and having a plurality of compressor blades extending radially outward from the rotor assembly. The compressor section also includes a plurality of compressor vanes, which remain stationary and are also referred to as diaphragm airfoils, extending radially inward from the casing. The compressor blades and compressor vanes are aligned into rows, or stages, and are positioned in alternating rows of compressor vanes and compressor blades. The compressor vanes are typically attached to the casing via a hook fit. By hook fit, it is meant that the radially outward ends of the compressor vanes have hooks which fit into grooves of the casing. The radially inward ends of the compressor vanes have grooves which receive hooks of the inner shroud which is attached to the rotor. These hook fits releasably and securely attach the compressor vanes within the casing.

A component of a combustion turbine is routinely subjected to harsh environments that include rigorous mechanical loading conditions from room temperature to high temperatures. For example a diaphragm airfoil, compressor vane, casing, and blade ring may experience vibrations and dynamic forces that cause undesirable wear. Such a component can be provided with wear resistant coatings to reduce maintenance intervals and increase the life of the component.

One method of applying a wear resistant coating to a substrate is known as thermal spraying. Thermal spraying is a continuous process wherein material is melted and accelerated to high velocities to impinge on a substrate, where it rapidly solidifies to form a thin “splat.” The melting and acceleration of the molten particles is typically provided by a combustion flame or thermal plasma.

Some efforts at providing effective wear resistant coatings have focused on the use of amorphous metals, also known as metallic glass, in the coating. For example, U.S. Pat. No. 6,767,419 to Branagan discloses a method of forming a wear resistant coating including the formation of a metallic glass coating over a metallic substrate. After formation of the coating, a portion of the metallic glass is subjected to a devitrification process to form a crystalline steel material having a nanocrystalline grain size. This resulting coating provides the substrate with improved wear resistance.

Likewise, a method of providing a wear resistant coating including amorphous metals is disclosed in U.S. Pat. Pub. No. 2005/1023686 to Myrick. Myrick discloses maintaining a substrate at a temperature below the crystallization temperature of an amorphous metallic alloy. A powder made from the amorphous metallic alloy is vaporized and condensed on the surface of the substrate, forming the wear resistant coating. This process can be repeated multiple times to increase the thickness of the wear resistant coating.

Other efforts at providing effective wear resistant coatings have focused on the usage of ceramics in the coating. U.S. Pat. Pub. No. 2007/0243335 to Belashchenko, for example, discloses a method of creating a wear resistant coating made from a composite of a metal and a ceramic. A composite powder having both a metallic component and ceramic component is deposited, using conventional deposition techniques, on a metal substrate to create the wear resistant coating. The metallic component of the powder includes both crystalline and amorphous metals.

In some applications, however, wear resistant coatings made from different materials that have different characteristics may be desirable.

### SUMMARY OF THE INVENTION

In view of the foregoing background, it is therefore an object of the present invention to provide a method for forming an enhanced wear resistant coating.

This and other objects, features, and advantages in accordance with the present invention may be provided by a method of forming a wear resistant coating on a workpiece. The method may include atomizing a metallic liquid comprising molybdenum in an atmosphere to form a crystalline metallic powder. The crystalline metallic powder may be milled to form a nanocrystalline metallic powder. Moreover, the method may include thermal spraying the nanocrystalline metallic powder comprising molybdenum onto the workpiece. Thermal spraying the nanocrystalline metallic powder onto the workpiece advantageously provides the workpiece with enhanced wear resistance.

The workpiece may comprise a combustion turbine component, for example. The combustion turbine component may comprise a compressor vane, a compressor vane mount, a compressor vane hook, a casing, a inner shroud, or a inner shroud hook. A bond coating may be formed on the workpiece prior to thermal spraying. The bond coating may enhance bonding of the wear resistant coating to the workpiece. The metallic liquid may be atomized in an inert atmosphere. Alternatively, the metallic liquid may be atomized in an oxidizing atmosphere. Atomizing the metallic liquid in an oxidizing atmosphere may facilitate the formation of in-situ oxide shells that may enhance certain properties of the metallic liquid.

Milling the metallic powder may include cryomilling or ball milling Milling the metallic powder may also include jet milling.

The thermal spraying may comprise thermal combustion spraying, for example high velocity oxy fuel (HVOF) spraying. The thermal spraying may also comprise thermal plasma spraying. The nanocrystalline metallic powder comprising molybdenum may also include at least one other metallic compound, for example at least one of NiCrBSi, C, S, AlSi, Al₂O₃, MoS₂, brass, and bronze.

### BRIEF DESCRIPTION OF THE DRAWINGS

FIG. 1 is a flowchart of a method in accordance with the present invention.

FIG. 2 is a flowchart of an alternative embodiment of a method in accordance with the present invention.

FIG. 3 is a front perspective view of a turbine blade having a wear resistant coating formed thereon in accordance with a method of the present invention.

FIG. 4 is a greatly enlarged cross sectional view of the turbine blade taken along line 4-4 of FIG. 3.

FIG. 5 is a schematic cross sectional view of a casing, compressor vane, and inner shroud having a wear resistant coating formed thereon in accordance with a method of the present invention.

FIG. 6 is a greatly enlarged cross sectional view of the upstream radially outward hook fit of FIG. 5.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

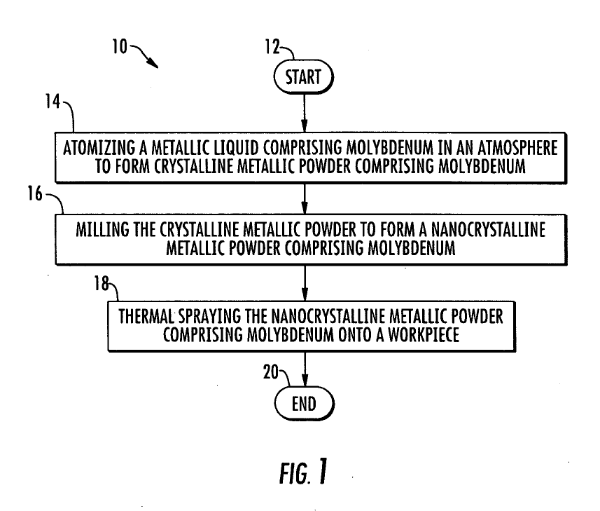

A first embodiment of a method of forming a wear resistant coating on a workpiece in accordance with the present invention is now described generally with reference to the flowchart 10 of FIG. 1. After the start (Block 12), at Block 14, a metallic liquid comprising molybdenum is atomized in an atmosphere to form a crystalline metallic powder comprising molybdenum. An exemplary starting metallic liquid comprises at least 50% molybdenum. Molybdenum can withstand high temperatures without significant expansion or softening. Additionally, molybdenum has a high corrosion resistance.

Other preferred metallic liquids comprising molybdenum include NiCrAlMo, NiCoCrAlMo, CoNiCrAlMo, and FeCrAlMo alloys. Those skilled in the art will appreciate that the metallic liquid may be formed by melting ingots of a pure metal or of a desired alloy. Moreover, the metallic liquid may be formed by melting ingots of different metals, mixing when melted or during melting to form a metallic liquid containing an alloy. Furthermore, the metallic liquid may be formed by melting a metallic powder. Various processes may utilized to melt the ingots or powder.

At Block 16, the crystalline metallic powder comprising molybdenum is milled to form a nanocrystalline metallic powder comprising molybdenum. The crystalline metallic powder may be milled for a desired length of time and according to one or more conventional milling processes as understood by those skilled in the art. Furthermore, the crystalline metallic powder may be milled multiple times by the same milling process, or may alternatively be milled multiple times by different milling processes.

At Block 18, the nanocrystalline metallic powder comprising molybdenum is thermally sprayed onto the workpiece. It is to be understood that any of a number of commercially available thermal spraying process may be employed, melting the nanocrystalline metallic powder.

The nanosize of the nanocrystalline metallic powder may advantageously allow for a finer splat structure that results in a more dense wear resistant coating. This greater density may facilitate superior properties, such as decreased porosity, greater hardness, greater creep resistance, and enhanced wear resistance. In addition, the wear resistant coating advantageously may not include any ceramics, to enhance wear resistance and to increase tensile strength.

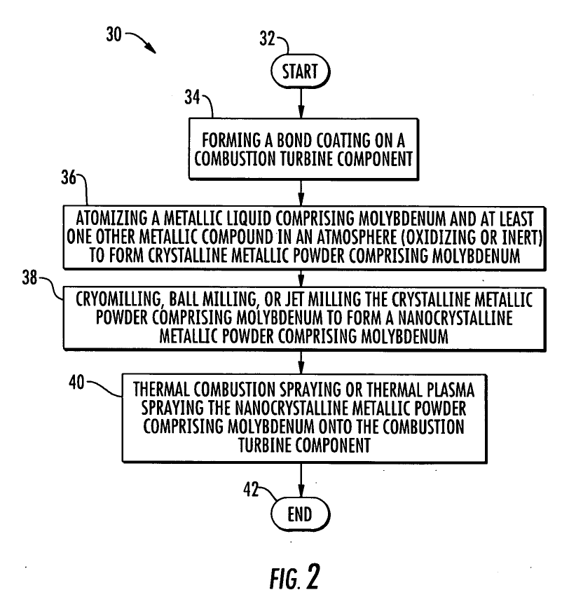

Referring now to the flowchart 30 of FIG. 2, an alternative embodiment of the method of forming a wear resistant coating on a combustion turbine component is now described. After the start (Block 32), at Block 34, a bond coating is formed on a combustion turbine component. The bond coating may be formed on the combustion turbine component using techniques and materials known to those skilled in the art. For example, the bond coating may comprise a brazing layer.

At Block 36, a metallic liquid comprising molybdenum and at least one other metallic compound is atomized in an atmosphere to form crystalline metallic powder. It will be appreciated by those of skill in the art that the at least one other metallic compound may be a metallic compound also containing no ceramics therein and forming a nanocrystalline metallic powder. For example, the at least one other metallic compound may comprise a crystalline metallic compound as opposed to an amorphous metallic compound. The at least one other metallic compound may include at least one of NiCrBSi, C, S, AlSi, Al₂O₃, brass, and bronze.

It will be appreciated by those of skill in the art that the atmosphere may be an oxidizing atmosphere, at a desired temperature, and at a desired pressure. Atomizing the metallic liquid in an oxidizing atmosphere may facilitate the formation of in-situ oxide shells that may enhance certain properties of the metallic liquid.

In some embodiments, the atmosphere may instead be an inert atmosphere, preferably comprising nitrogen and/or argon, although it is to be understood that other inert atmospheres, or even a vacuum, may be used. Atomization in such an inert atmosphere may increase the likelihood that each droplet or particle formed during the atomization process has a uniform size, shape, and/or chemistry.

At Block 38, the crystalline metallic powder is cryomilled, ball milled, and/or jet milled to form a nanocrystalline metallic powder.

At Block 40, the nanocrystalline metallic powder is thermal combustion sprayed and/or thermal plasma sprayed onto the combustion turbine component at any temperature, velocity, and distance from the combustion turbine component.

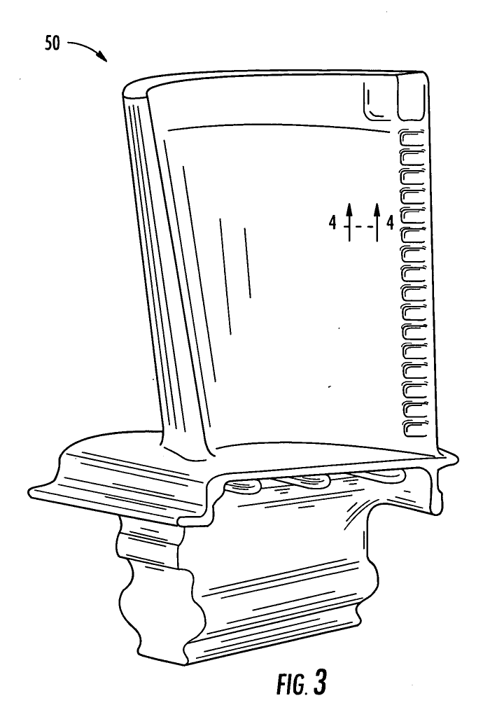

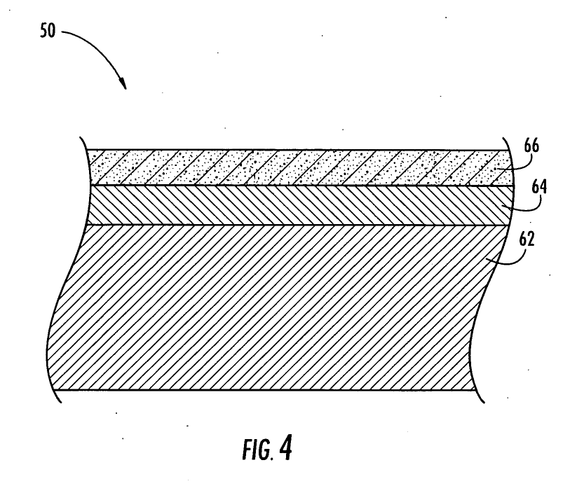

Referring now additionally to FIGS. 3-4, a turbine blade 50 having a wear resistant coating 52 formed in accordance with the method of the present invention is now described. The turbine blade 60 comprises a metal substrate 62. A bond coating 64 is formed on the metal substrate 62. The wear resistant coating 66, as described above, is formed on the bond coating 64.

It will be readily understood by those of skill in the art that the wear resistant coating 66 discussed above could be formed on any combustion turbine component such as a blade root, a turbine vane, a compressor vane root, or a blade ring groove. The wear resistant coating methods described herein may also be used on other workpieces as will be appreciated by those skilled in the art.

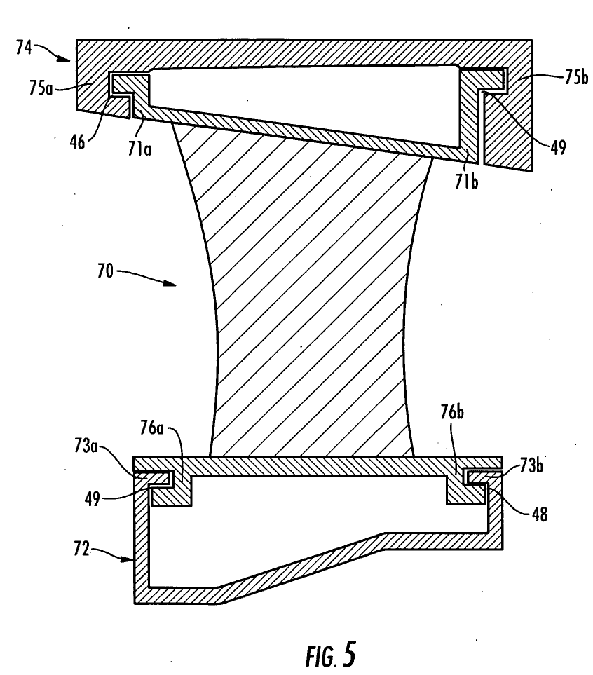

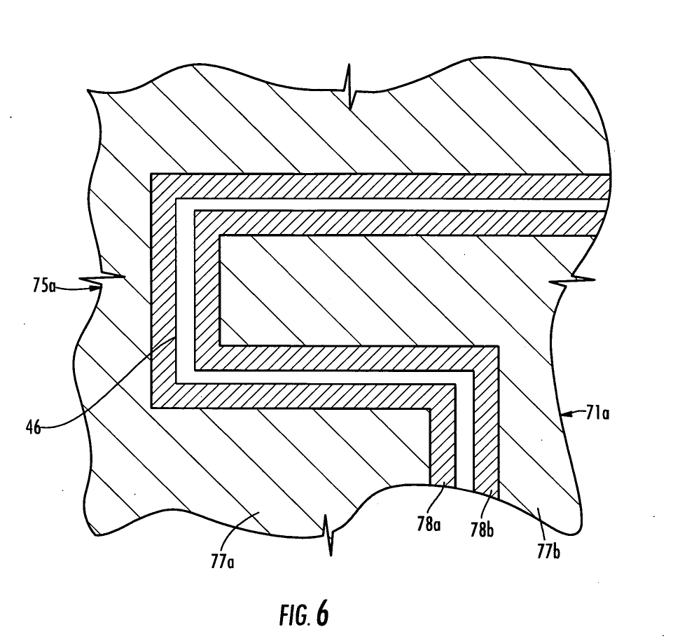

Referring now additionally to the schematic cross sectional views of FIGS. 5-6, a compressor vane 70, a inner shroud 72, and a casing 74, each having a wear resistant coating 78 formed in accordance with the method of the present invention is now described. Compressor vane hooks 71a, 71b are located at the radially outward end of the compressor vane 70 and compressor vane grooves 76a, 76b are defined in the radially inward end of the compressor vane. Inner shroud hooks 73a, 73b extend from the radially outward portion of the inner shroud 72 and casing grooves 75a, 75b are defined in the casing 74. The compressor vane hooks 71a, 71b are positioned within the casing grooves 75a, 75b and the compressor vane grooves 76a, 76b are positioned around the inner shroud hooks 73a, 73b, to define an upstream radially outer hook fit 46, a downstream radially outward hook fit 47, a downstream radially inward hook fit 48, and an upstream radially inward hook fit 49.

The compressor vane 70 and casing 74 each comprise a metal substrate 77a, 77b with a wear resistant coating 78a, 78b as described above, formed thereon. It should be understood that a bond coating (not shown) may optionally be formed on the metal substrate 77a, 77b and that the wear resistant coating 78a, 78b may be formed on the bond coating.

It should also be understood that, in some applications, the compressor vane hooks 71a, 71b, compressor vane grooves 76a, 76b, the inner shroud hooks 73a, 73b, and the casing grooves 75a, 75b may each have the wear resistant coating 78a, 78b formed thereon. In other applications, the compressor vane hooks 71a, 71b, compressor vane grooves 76a, 76b, the inner shroud hooks 73a, 73b, and the casing grooves 75a, 75b may not each have the wear resistant coating 78a, 78b formed thereon.

Applicants have found premature material loss at the hook fits 46, 47, 48, 49. Furthermore, Applicants have identified the cause of this material loss as fretting wear (a repeated cyclical rubbing between two surfaces). Wear to the compressor vane hooks 71a, 75b and the casing grooves 75a, 75b has been found to be caused by contact therebetween resulting from aerodynamic loading, vibration, and heat. Wear to the compressor vane grooves 76a, 76b and the inner shroud hooks 73a, 73b has been found to be caused by migration of the turbine vane 70 upstream and the resulting contact with adjacent components, caused by aerodynamic loading.

The wear occurs at predominantly three surfaces: the upstream radially outer hook fit 46, the downstream radially outward hook fit 47, and the downstream radially inward hook fit 48. Applicants have found that application of the wear resistant coating 78 to the hook fits 46, 47, 48 49 advantageously reduces the wear caused by fretting. In addition to providing wear and impact resistance, the nanostructured molybdenum coating formed nanosized debris as it wears. This nanosized debris creates a lubricious layer at the hook fits 46, 47, 48, 49 and further helps to reduce wear.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A method of forming a wear resistant coating on a workpiece comprising:
atomizing a metallic liquid comprising molybdenum in an atmosphere to form a crystalline metallic powder comprising molybdenum;
milling the crystalline metallic powder comprising molybdenum to form a nanocrystalline metallic powder comprising molybdenum; and
thermal spraying the nanocrystalline metallic powder comprising molybdenum onto the workpiece.

2. A method according to claim 1 wherein the workpiece comprises a combustion turbine component.

3. A method according to claim 2 wherein the combustion turbine component comprises a compressor vane.

4. A method according to claim 2 wherein the combustion turbine component comprises a compressor vane mount.

5. A method according to claim 1 further comprising forming a bond coating on the workpiece prior to thermal spraying.

6. A method according to claim 1 wherein the atmosphere comprises an inert atmosphere.

7. A method according to claim 1 wherein the atmosphere comprises an oxidizing atmosphere.

8. A method according to claim 1 wherein milling the metallic powder comprises at least one of cryomilling, ball milling and jet milling.

9. A method according to claim 1 wherein thermal spraying comprises at least one of thermal combustion spraying and thermal plasma spraying.

10. A method according to claim 1 wherein the nanocrystalline metallic powder comprising molybdenum further comprises at least one of NiCrBSi, C, S, AlSi, Al₂O₃, brass, and bronze.

11. A method of forming a wear resistant coating on a combustion turbine component comprising:
forming a bond coating on the combustion turbine component;
atomizing a metallic liquid comprising molybdenum in an atmosphere to form a crystalline metallic powder comprising molybdenum;
milling the crystalline metallic powder comprising molybdenum to form a nanocrystalline metallic powder comprising molybdenum; and
thermal spraying the nanocrystalline metallic powder comprising molybdenum onto the bond coating of the combustion turbine component.

12. A method according to claim 11 wherein milling the metallic powder comprises at least one of cryomilling, ball milling and jet milling.

13. A method according to claim 11 wherein thermal spraying comprises at least one of thermal combustion spraying and thermal plasma spraying.

14. A method according to claim 11 wherein the nanocrystalline metallic powder comprising molybdenum further comprises at least one of NiCrBSi, C, S, AlSi, Al₂O₃, brass, and bronze.

15. A method of forming a wear resistant coating on a combustion turbine component comprising:
atomizing a metallic liquid comprising molybdenum and at least one of NiCrBSi, C, S, AlSi, Al₂O₃, brass, and bronze in an atmosphere to form a crystalline metallic powder comprising molybdenum;
milling the crystalline metallic powder comprising molybdenum to form a nanocrystalline metallic powder comprising molybdenum;
thermal spraying the nanocrystalline metallic powder comprising molybdenum onto the combustion turbine component.

16. A method according to claim 15 further comprising forming a bond coating on the combustion turbine component prior to thermal spraying.

17. A method according to claim 15 wherein milling the metallic powder comprises at least one of cryomilling, ball milling and jet milling.

18. A method according to claim 15 wherein thermal spraying comprises at least one of thermal combustion spraying and thermal plasma spraying.
